(19) United States
(12) Patent Application Publication
(10) Pub. No.: US 2006/0195610 A1
(43) Pub. Date: Aug. 31, 2006

(54) Security Enhanced Methods And System For IP Address Allocation

(75) Inventors: Eric B. Cole, Leesburg, VA (US); Huy Vu, Oak Hill, VA (US)

Correspondence Address: MARTIN & HENSON, P.C., 9250 W 5TH AVENUE, SUITE 200, LAKEWOOD, CO, 80226, US

(73) Assignee: SYTEX, INC., Doylestown, PA (US)

(21) Appl. No.: 10/906,632

(22) Filed: Feb. 28, 2005

(51) Int. Cl. G06F 15/16

(52) U.S. Cl. 709/245

(57) ABSTRACT

The present invention relates to methods and a system for enhancing DHCP to promote a more secure IP address allocation model. The invention advantageously accomplishes this through the utilization of an address generator which is compatible with the existing DHCP protocol, and which incorporates an algorithm for use in producing a selected IP address as one of a sub-set of allocable addresses that are non-sequentially distributed within an address pool. As such, the invention offers robust security and allows for the rapid detection of unauthorized activity such as network intrusion, worms, virus propagation, network scanners, and SPAM.

### BACKGROUND OF THE INVENTION

The present invention broadly concerns the passing of configuration information to hosts on a network, such as a TCP/IP network. More particularly, the invention relates to methods and systems for automatically allocating temporary or permanent addresses to authorized hosts on the network via enhanced security protocols.

Almost all corporate networks implement the Dynamic Host Configuration Protocol (DHCP) due to the ease and maintainability of hosts connecting to the network. The DHCP specification, as defined by the Internet Engineering Task Force (IETF) at RFC2131 and RFC 3396, was designed for network administrators to centrally manage and automate the assignment of Internet Protocol (IP) addresses and other network configuration parameters. Without DHCP, the IP address and other network configurations must be entered manually into each computer. For small organizations with no more than twenty hosts, for example, this is manageable but inconvenient. However, for larger organizations it can translate into a critical maintenance problem. DHCP deployment is particularly needed in today's mobile environment with multi-site organizations having employees who travel regularly from one location to another. However, often attendant with this ease of automation is a sacrifice to security on the network.

When a computer initially connects to a network it has no knowledge about the network, such as how to communicate with other hosts or access the Internet. With reference to the timeline diagram of FIG. 1, one of the first things it does (presuming it is configured for DHCP) is to broadcast a DHCP request DHCPDISCOVER message at 1. Since the message is a broadcast, all hosts on the local subnet will receive the request; however, assuming there are no malicious hosts responding, only the DHCP server or a DHCP relay will act on the message. If there is no DHCP server on the LAN, a DHCP relay is required to forward the request to the server on a different segment. Once the server is contacted, the request is processed and the DHCP server usually has a block of dynamically allocated address where one is allocated and returned to the requesting client at 2 via a DHCPOFFER message. Current DHCP implementations typically allocate these IP addresses base on rudimentary and predictable assignment schemes, such as sequentially, so that the allocated address are not uniformly distributed within an the available address space.

Accompanying the server's DHCPOFFER response message is information such as network address, broadcast address, domain name, DNS servers, etc. DHCP uses the concept of a “lease”, which is the amount of time a given IP address will be valid for a computer. The lease time can vary depending on how long a user is likely to require the network connection at a particular location. DHCP also supports static addresses for hosts requiring static addresses to be mapped. Other messages exchanged between the clients and servers, namely the DHCPREQUEST message 3, the DHCPACK message 4 and the DHCPRELEASE message 5 which shown in FIG. 1, are described in greater detail in the RFC 2131 specification.

Once a host receives the server's response, it will bring up the network interface with the information provided. It will also add routes and store the information, such as Domain Name System (DNS) software, to a file for later use. The DHCP client mainly remains dormant at this point until the lease time has expired, at which point it is responsible for reconfiguring the network information.

DHCPv4 (RFC 2131) is a mature, stable and widely used protocol for automatic configuration of hosts in an IPv4 network. DHCP is an alternative to another network IP management protocol, known as the Bootstrap Protocol (BOOTP). While DHCP is a more advanced protocol, but are in common use. DHCP protocols are normally used in “computer host” environments whereas BOOTP is normally used in a “diskless” or network boot scheme used in an embedded environment. Some organizations actually use both protocols, and this capability is facilitated by an implementation of DHCP that also supports BOOTP.

DHCP was not provisioned for authentication of clients and servers, nor did it provide for content integrity checking. These limitations were not addressed in the original RFC but rather were left for future work. Beginning in about 1995, DHCP security began to attract attention from the Internet community, eventually resulting in the publication of RFC 3118 in 2001. Although RFC 3118 was a mandatory prerequisite for the DHCPv4 Reconfigure Extension, RFC 3203, it has had no known usage by any commercial or private implementation since its adoption.

Thus, while DHCP is widely deployed, it does have exploitable security vulnerabilities. For instance, the following issues have been identified in addressing the threat analysis of RFC 2131: denial-of-service attacks; refusal to configure clients; impersonation of clients; flooding; client mis-configuration; theft of network service; and packet insertion, deletion, or modification. As for RFC 3118, identified weakness include key exposure, key distribution and replay attacks.

For network administrators it becomes important to promote security by only letting authorized hosts connect to their network. Worms are destructive programs which infiltrate network hosts and replicate themselves in disks and memory, eventually exhausting computer resources. There are many algorithms that a scanning worm can use. For example, the worm might initially select a random IP address and then scan the address space. Alternatively, address selection may be completely random, or biased toward local addresses, or be a more enhanced technique such as permutation scanning. Regardless of the scanning technique, the worm attempts to guess the usable IP ranges of addresses to infect. It has been suggested that a robust worm defense requires an approach similar to containment because worms can find (by brute force) small holes in firewalls, VPN tunnels from other institutions, infected notebook computers, web browser vulnerabilities, and email-borne attacks. Without containment, even a single breach can lead to a complete internal infection. Worms represent only one type of malicious activity which can affect network resources. Other types of activity can be less harmful, but a nuisance nonetheless. One well-known example is SPAM, which is the transmission of numerous copies of the same message to network users or newsgroups. For example, with worms and SPAM at record highs, it is critical for network administrators to detect unauthorized network access and disable infected hosts (the source of the intrusion) before unauthorized activities such as these spread to other systems.

In an effort to address the problem of unauthorized network access, a known technique that can be used, but rarely is practiced, is to lock down hardware addresses to certain IPs. Each device connected to an Ethernet network has two addresses, a Medium Access Control (MAC) address and an Internet Protocol (IP) address. Information is currently routed over the Internet by using a 4-byte IP address. However, packets are routed on each segment by a hardware address. According to the IEEE standard 802.3 for Ethernet, this hardware address is a 6-byte MAC address built into each network interface. Thus, a sending host on a Ethernet network can communicate with a target host on the LAN only if it knows the MAC address of the target host.

When communication is desired, the sending host references the target host via its IP address which is then resolved to the corresponding link layer MAC address. The address resolution protocol (ARP), as defined by the IETF at RFC 826, is predominately used with IEEE 802.X compliant LAN architectures to perform mapping of an IP addresses to a MAC addresses on a local network. Essentially the protocol sends out a broadcast address asking all hosts on the LAN to return the MAC address associated with the IP address with whom the sending host wants to communicate. The host owning the IP responds with its own MAC address or a gateway may recognize the IP from its routing table and respond with the MAC address of the gateway. The Reverse Address Resolution Protocol (RARP), defined by the IETF at RFC 903, performs the reverse operation of ARP by resolving an IP address from a MAC address.

The concept of locking down MAC addresses to certain IPs may, at first blush, be an appealing approach to preventing unauthorized access to a network's resources. Unfortunately though, given the time which might be entailed to enter all the appropriate information to accomplish this, an administrator could instead simply assign each host a static IP based on its MAC addresses. In any event, while this approach might resolve the problem of unauthorized hosts connecting to the network, it would not detect and prevent worms or SPAM from spreading over the network. Thus, statically assigned IPs and manual host configurations are simply not practical for multi-site/multi-subnet organizations. In the end, network administrators typically default to using a “trusted” model in which everyone on the network is allowed to have an IP regardless of authorization status.

Accordingly, there remains a need to provide an enhanced approach for automatically allocating addresses to hosts on a network. There is a particular need for a new and improved approach which enhances security through the implementation of safeguards for reasonably ensuring that addresses are only allocated to authorized hosts with established credentials. The present invention is directed to satisfying these unresolved needs.

### BRIEF SUMMARY OF THE INVENTION

The present invention relates to methods and a system for enhancing DHCP to promote a more secure Internet Protocol (IP) address allocation model. In its various forms, the invention is suitable for use on a local subnet which is characterized by a subnet mask IP address, with the local subnet including a DHCP compatible server and at least one DHCP compatible client.

According to one exemplary embodiment of a method, an address discover message is broadcast from the DHCP compatible client onto the local subnet. A valid IP address is generated for offering to the DHCP compatible client. This valid IP address is advantageously one of a sub-set of allocable IP addresses which is non-sequentially distributed within an address pool. The valid IP address is offered to the DHCP client and allocated to the client once it has been accepted.

The valid IP address is preferably generated by an address generator which resides on the server. Preferably also, this address generator produces the valid IP address utilizing a selected algorithm which is operative to generate non-sequential resultant values based on a linear input variable. The sub-set of allocable IP addresses may then be defined by mapping each of the resultant values to the subnet mask IP address according to a logical bitwise OR operation. To this end, the algorithm may be a non-linear function or a linear function which accomplishes the non-sequential distribution. Advantageously also, the algorithm may be selected from a group of suitable algorithms.

The algorithm is characterized by a valid function identifier, and the valid IP address is only offered to the DHCP compatible client upon determining that the client posses this valid function identifier. In this regard, the DHCP client can incorporate a target function identifier within the options field of a DHCPREQUEST unicast message. A dummy DHCPOFFER message can be generated to trigger the DHCPREQUEST message. The server can parse the DHCPREQUEST message to ascertain if the target function identifier matches the valid function identifier. In this manner, the DHCP client becomes authenticated to the DHCP server. Provision is also made to authenticate the DHCP server to the DHCP client. This may be accomplished by passing the offered IP address from the DHCP server to a match filter residing on the client so that the client can ascertain the address' validity. Only upon ascertaining validity, then, will the DHCP client accept the offered IP address. Thus, another embodiment of a method more specifically contemplates the generation of a selected IP address for offering to the DHCP compatible client, with the client ascertaining its validity prior to acceptance.

The invention also relates to a system for allocating an IP address on a local subnet. The system broadly comprises a client computer system (such as a DHCP compatible client) for broadcasting the IP address request along the local subnet, and a server computer system (such as a DHCP compatible server) for selectively offering a valid IP address to the client in response to such request. Here again, the valid IP address is advantageously one of a sub-set of allocable IP addresses, which sub-set is non-sequentially distributed within the address pool. The system of the present invention may also advantageously incorporate those features discussed above with reference to the contemplated methodologies.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a timeline diagram, according to the prior art dynamic host configuration protocol (DHCP), of messages exchanged between DHCP compatible clients and servers during network address allocation;

FIG. 2 is a diagram showing an architectural overview of a security enhanced DHCP system in accordance with the present invention;

FIG. 3 is a block diagram representing possible I/O parameters for the server's IP address generator depicted in FIG. 2;

FIG. 4 is a block diagram representing I/O parameters and functionalities for the client side's match filter depicted in FIG. 2;

FIG. 5 represents an exchange message that conforms to the DHCP protocol structure, and which incorporates a function identifier within its options field; and

FIG. 6 represents a high level flow chart for software which implements the functions of the match filter; and

FIG. 7 represents an exemplary network communications device that may be configured to implement aspects of the present invention.

### DETAILED DESCRIPTION OF THE INVENTION

To address the exploitable security vulnerabilities noted above in the Background section, the present invention relates to an algorithm for use in enhancing DHCP to promote a more secure address allocation model. In this way, the algorithm can be used in conjunction, for example, with DHCP for early network intrusion detection, detection of worms and virus propagation, network scanners, and SPAM.

The model itself borrows principles from Code Division Multiple Access (CDMA), which is a technique for transmitting simultaneous signals over a shared portion of a spectrum. Spread spectrum is a fairly new technique for channel allocation. Prior to CDMA, other technologies in use were frequency division multiple access (FDMA) and time division multiple access (TDMA). In FDMA, channels are allocated from a fixed frequency base and allocated to communcation channels. In TDMA, the time slots are divided for communication devices. From a security standpoint, communications which utilize either TDMA or FDMA are inherently vulnerable in that eavesdropping on the communication can be accomplished by tuning to the correct time slot in the case of TDMA, or the correct frequency in the case of FDMA.

In a CDMA system each user's data is spread over the available bandwidth (spread spectrum) with distinct code sequences that are orthognal to one another. Unless the particular coded sequence is known, the received signals appear as noise. Thus, in any CDMA system a good cross-correlation function is required in order to decode the spread signal by detecting the signal obscured by the noise. Another technique in the family of spread spectrum is known as frequency hopping. In frequency hopping CDMA the carrier frequency of the modulated information signal is not constant but changes periodically. During time intervals T the carrier frequency remains the same, but after each time interval the carrier hops to another (or possibly the same) frequency. The hopping pattern is determined by the code signal. The set of available frequencies the carrier can attain is called the hop-set. Pseudo-random sequences, called keys, are used to obtain the hop-set and allocate channels in frequency hopping CDMA.

For the enhanced address allocation scheme of the present invention, the entire range of available IP addresses for the network or a portion thereof (i.e. the address pool) is analogous to the frequency “spectrum” from which communication channels are allocated. Further, those addresses from the address pool which are deemed valid and available for allocation according to the scheme (i.e. the sub-set of allocable addresses) are analogous to the hop-set used in frequency hopping CDMA. Algorithm-based sequencing is used to generate this allocable sub-set in a manner, advantageously, distributes them non-sequentially throughout the address pool so that attempts to guess a valid address become more difficult. Moreover, an attempt to use an invalid IP address (i.e. one not within the allocable hop-set) can be readily ascertained and is considered an attempted security breach.

An IP address generator is employed to generate the valid IP addresses, and it can selectively employ any one or more of a variety of administrator-defined functions. The particular function(s) employed by the address generator would be a matter of user preference based on various considerations including a desired security level, ease of implementation, etc. However, for illustrative purposes, a simplified algorithm might include a linear function f(n)=a·n+b, or a non-linear function such as a quadratic function f(n)=a·n²+b, or a Fibonacci sequence, to name a few. Where a linear function is selected, it is preferred to chose “a” to be a constant other than “1” to avoid sequential address allocation which plagues existing models and renders them vulnerable to easy exploitation. From a network administrator's perspective, the complexity of the algorithm is of less concern than its quality. Indeed, it is contemplated that the network administrator can have a list of possible algorithms from which to choose, with this list ranging from simple to complex if desired. It is also preferred that the selectable algorithm(s) not be known outside of the organization. Understandably, the security of the function(s) will only be as sufficient as the organization's efforts to preserve its secrecy to avoid compromise. Enhanced security can also be provided by incorporating an expiration parameter into the address allocation scheme, thereby mitigating risk at the expense of protocol complexity.

For purposes of illustration, a simplified implementation could utilize an even number address generator function, f(n). Assuming a subnet of 192.168.x.y, there are 2¹⁶-2 possible IP addresses in the address pool, taking into account the network address and the broadcast address which necessarily are not allocable to DHCP clients. Thus, only a subset of IPs generated by the function f(n) would be valid and allocable IPs in such a network—in this case the even IPs. Any odd number IP is, thus, deemed invalid. A match filter is employed to detect the even IPs. The match filter may itself be a function which accomplishes detection according to a binary operation such as: M(n)=[(n|0×1)==0]. From the description to follow, the ordinarily skilled artisan should thus appreciate that the DHCP enhancements described herein are algorithmic in nature and not protocol based. As a result, the characteristics of the network traffic across the transmission medium would be unaffected.

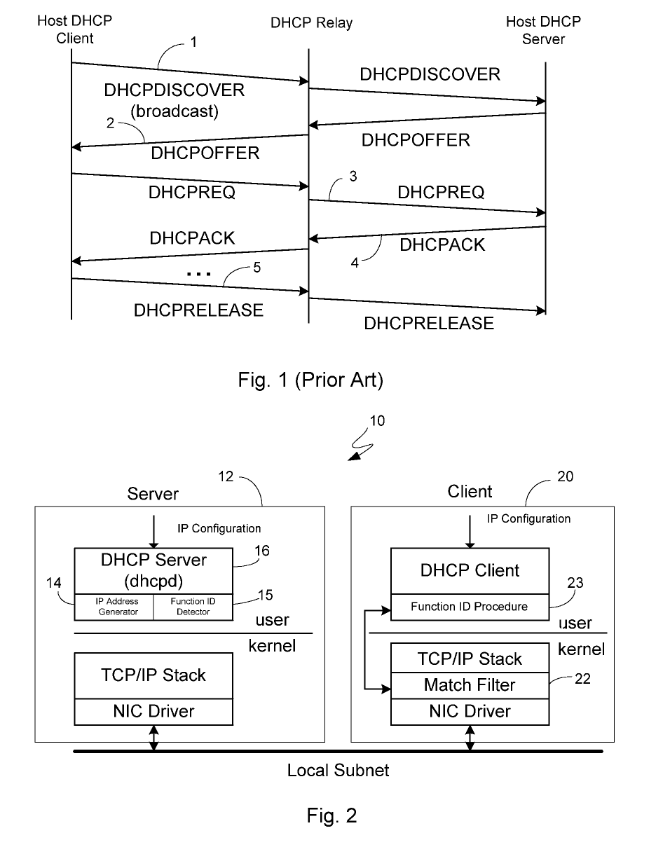

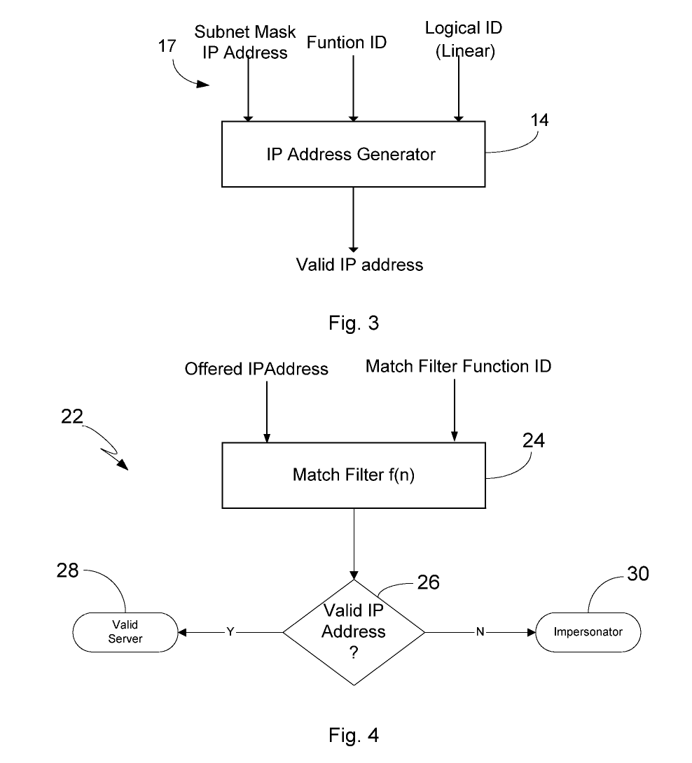

The algorithmic changes impact both server and client participants of a DHCP messaging exchange. To illustrate this, FIG. 2 is an architectural overview of an enhanced DHCP system 10 according to the invention. On the server side 12 most of the modifications can be made in userland in the “dhcpd” daemon. An algorithmic block in the form of an IP address generator 14 resides in user space along with the dhcp server 16. Preferably also, a function ID detector 15 (discussed below) is associated with the DHCP compatible server 12. As illustrated in FIG. 3, address generator 14 generates a valid IP address based on a plurality of inputs, generally 17, which include the subnet mask IP address, a function identifier and a logical identifier.

More particularly, the function ID preferably corresponds to one of a plurality of algorithms which has been selected by the administrator during configuration of the server for use in address generation. IP address generator 14 is capable of retrieving the selected algorithm based on the function ID which is passed to it. The logical ID input to the address generator 14 is simply a linear variable which is supplied to the selected algorithm to generate a respective resultant value which can be considered a mapping ID. During use, IP address generator 14 would increment the linear variable accordingly to avoid generating duplicate valid IP addresses. The mapping ID produced by the selected algorithm is mapped to the subnet mask IP address preferably through a bitwise OR binary operation to produce the valid IP address. In this regard, IP address generator 14 functions similarly to those prevalent in existing DHCP address allocation models.

However, existing models have limited versatility and allocate addresses in a manner which separates them in blocks, leading to non-uniform distribution of valid and invalid spaces throughout the address pool. More particularly, existing approaches utilize a single linear algorithm of the form f(n)=a*n+b, where a=1 and b=some offset value. It can be appreciated that address allocation according to this approach results in a sequential distribution of valid addresses which is easily detectable.

In contrast, the present invention endeavors to adopt an address allocation scheme which spreads the allocable IP addresses throughout the entire address pool. To this end, the algorithm(s) which are utilized by the IP address generator 14 are such that they preferably produce resultant values which are non-sequentially distributed. As such, address generator 14 produces valid IP addresses derived from these resultant values which form part of sub-set of allocable IP addresses which are not sequentially distributed throughout the address pool. To accomplish this “spread spectrum” address pool distribution, the selected algorithm, for example, can be a non-linear function or a linear function where the constant “a” is a value other than 1. In doing so, the sub-set of allocable IP addresses becomes more difficult to identify compared to the known approach. Moreover, depending on the complexity of the algorithm(s) which may be selected to accomplish the non-sequential distribution, it can become exceedingly or infeasible difficult for one to ascertain a valid IP address for the network. Without knowledge of a valid IP address, network resources cannot be accessed, thus enhancing security.

To authenticate messages from the server side 12, the client side 20 in FIG. 3 incorporates a match filter 22 for ascertaining whether the offered IP address is a member of the allocable address subset (i.e. the hop-set). The functionalities of the match filter 22 may be appreciated with reference to FIG. 4 wherein it can be seen that the match filter 22 receives as inputs (generally 23) the offered IP address from the server, as well as a function identifier. These inputs are applied to a match filter function, represented by block 24, which compliments the selected algorithm used by address generator 14.

Continuing with the above example, then, if the address generator incorporates an algorithm for accomplishing the generation of even addresses as valid IPs, then the match filter 22 preferably incorporates an associated algorithm for detecting the even number IP addresses. In this regard, the match filter 22 can be considered a “hop-set” detector. In practice, the match filter 22 could generate the hop set using the IP generator algorithm and store these values within a hop-set lookup table. Then, for every IP that is passed through the match filter, a lookup could be performed to determine if it is within a hop-set table. If not, the address is considered valid. While this generalized approach, however, could be quite memory intensive since a full “hop-set” may consume many megabytes of memory.

Another possible approach, which would be both fast and efficient in terms of memory resources, would be the us of a hash look-up table. Still another method of implementing the match filter is more specific to the algorithm used to generate the offset. For example, if the even number generator is used, the match filter could simply check the least significant bit. If the LSB is 0 the IP address is even; otherwise, it is odd. For complex functions such as the Fibonacci sequence, there may be no other choice but to generate a lookup table. In any case, a determination is thus made at 26 in FIG. 4 as to whether the offered IP address is valid. If so, it is concluded at 28 that the server is valid. Otherwise, the server/host is deemed to be an impersonator at 30. At this point, the client host can either ignore the problem or report the suspicious event, e.g., via local logs or the like.

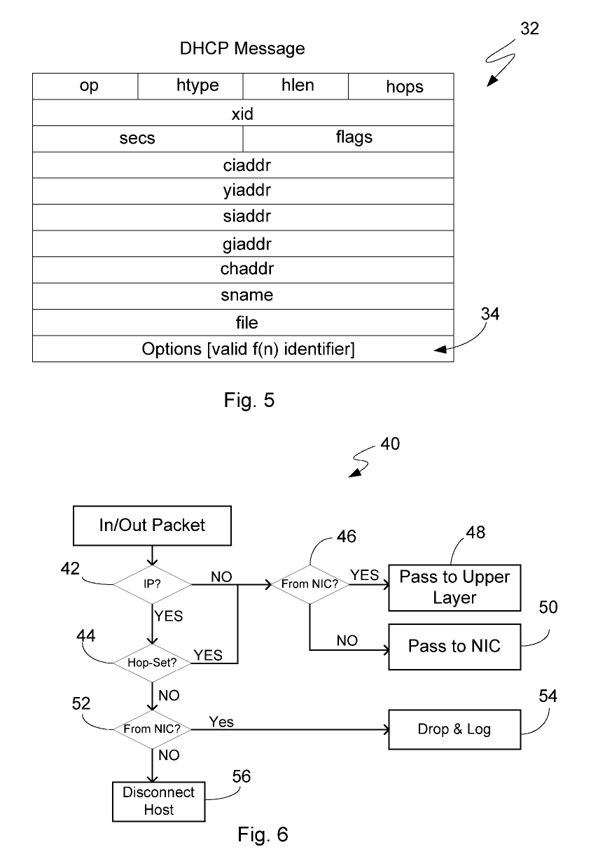

The DHCP client 20 is configured to have a cross-reference for each available algorithm to its associated function ID. The same holds true for the DHCP server 12. Thus, when these hosts communicate with one another and exchange messages in accordance with the DHCP protocol they preferably include the appropriate function identifier in their communications so that they can authenticate themselves to one another. To accomplish this capability, the function identifier is preferably included within the options field of at least some of the exchanged messages. This is illustrated in FIG. 5 which shows a representative DHCP message 50, which conforms to the DHCP protocol structure of RFC 2131, having the function identifier passed within options field 52.

A high level flow chart 40 is shown in FIG. 5 for the match filter processing which takes place on the client host. From FIG. 5 it may be seen that there are several outcomes to the match filter processing block. An inbound packet deemed to be from the network interface card (NIC) at 46 is passed to the upper layer (i.e. TCP/IP stack) at 48 if is also determined at 42 to be IP traffic, and if has an address at 44 which is part of the hop-set (i.e., the allocable IP address sub-set). However, if an inbound IP packet that is from the NIC at 52 is not within the hop-set at 44, it is dropped and logged at 54. A more drastic response can occur if an inbound packet has an invalid hop-set at 44 and does not originate from the NIC at 52. In such a situation, the host can be disconnected from the network at 58 since it has possible been compromised by a scanning worm. Such action would preferably require administrator intervention. As also shown in FIG. 5, an outbound IP packet which is part of the hop set at 44 is passed to the network interface card (NIC) at 50, while those which are not within the hop set will preferable result in disconnection of the host at 56 so that an assessment can be performed.

Initially the match filter 22 associated with the client is dormant. When the client initially connects to the network, it will broadcast a DHCPDISCOVER broadcast message in accordance with the DHCP protocol. The DHCPDISCOVER message is a means for the client to discover where the DHCP server resides. Once the DHCP server is discovered and its IP address is known, a unicast message is sent. The function ID is preferably included at this point in the options field of the unicast message and subsequent message exchanges between the client and server. Thus, the function ID processing block 23 is responsible for interfacing with the DHCP client to extract the information if it is transmitted via the protocol itself. In other cases the function ID may be a static parameter which the organization establishes as part of a host's DHCP configuration. Regardless of which method is used, a small code segment is required to pass on the configuration (function ID) to the IP match filter driver 22 residing inside the kernel between the NIC driver and the upper layer interfaces (i.e. TCP/IP stack).

Upon receipt of the DHCPDISCOVER broadcast message, the server will send a dummy DHCPOFFER message to trigger the client to transmit the DHCPREQUEST message. If the client is authentic, it should include a correct function ID for the server to conduct a comparison to ascertain if the target function ID matches the valid function ID which has been configured as an input to the server's IP address generator 14. For purposes of this determination, server 12 in FIG. 2 includes the function ID detector 15. Presuming the client transmits the appropriate function ID, it is considered to be authorized by the server. A malicious host, on the other hand would not know to include such data in the options field of any message exchanged with the server, and thus the DHCPREQUEST message would be deemed invalid and ignored.

A malicious client host could attempt to discover the function ID by sending repeated DHCPREQUEST messages, each incorporating a “test” function ID, until it receives an answer. However, this type of brute force approach can be thwarted by configuring the DHCP server (or DHCP relay) to detect this activity, and add the host to an offending list after repeated, unsuccessful attempts to ascertain the function ID. Thereafter, the DHCP server could simply fail to issue a response to any messages from the offending host.

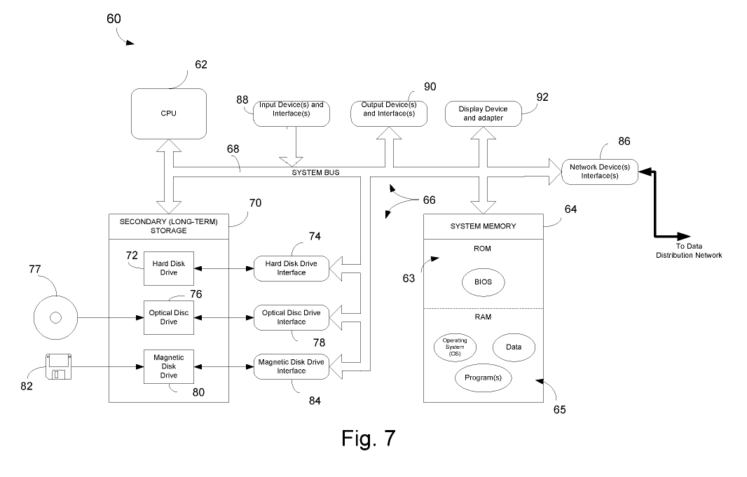

Both the DHCP compatible server and the DHCP compatible client can be suitably configured as a general purpose computer system 60 to have some or all of the characteristics as representatively depicted in FIG. 7. System 60 includes a processing unit, such as CPU 62, a system memory 64 and an input output (I/O) system, generally 66. These various components are interconnected by a system bus 68 which may be any of a variety of bus architectures. System memory 64 may include both non-volatile read only memory (ROM) 63 and volatile memory, such as static or dynamic random access memory (RAM) 65. Programmable read only memories (PROMs), erasable programmable read only memories (EPROMs) or electronically erasable programmable read only memories (EEPROMs) may be provided. ROM portion 63 stores a basic input/output system (BIOS) as shown. RAM portion 65 can store the OS, data, and/or programs for accomplishing the aspects of the invention. Computer system 60 may be adapted to execute in any of the well-known operating system environments, such as Windows, UNIX, MAC-OS, OS2, PC-DOS, DOS, etc.

Various types of storage devices can be provided as more permanent data storage areas which can be either read from or written to, such as contemplated by secondary storage region 70. Such devices may, for example, include a permanent storage device in the form of a large-capacity hard disk drive 72 which is connected to the system bus 68 by a hard disk drive interface 74. An optical disk drive 76 for use with a removable optical disk 77 such as a CD-ROM, DVD-ROM or other optical media, may also be provided and interfaced to system bus 68 by an associated optical disk drive interface 78. Computer system 60 may also have one or more magnetic disk drives 80 for receiving removable storage such as a floppy disk or other magnetic media 82 which itself is connected to system bus 68 via magnetic disk drive interface 84. Remote storage over a network is also contemplated.

One or more of the memory or storage regions mentioned above may comprise suitable media for storing programming code, data structures, computer-readable instructions or other data types for the computer system 60. Such information is then executable by processor 62 so that the computer system 60 can be configured to embody aspects of the present invention. Alternatively, the software may be distributed over an appropriate communications interface so that it can be installed on the user's computer system.

System 60 is adapted to communicate with a data distribution network (e.g., LAN, WAN, the Internet, etc.) via communication link(s). Establishing the network communication is aided by one or more network device(s) interface(s) 86, such as a network interface card (NIC), a modem or the like which is suitably adapted for connection to the system bus 68. System 60 preferably also operates with various input and output devices as part of I/O system 66. For example, user commands or other input data may be provided by any of a variety of known types of input device and associated system bus interfaces, generally 88. One or more output devices with associated system bus interfaces, generally 90, may also be provided. A monitor or other suitable display device and its suitable adapter, generally 92, may also be connected to the system bus 68.

Although certain aspects for the various participant computer systems may be preferred in the illustrative embodiments, the present invention should not be unduly limited as to the type of computers on which it runs, and it should be readily understood that the present invention indeed contemplates use in conjunction with any appropriate network communications device having the capability of being configured in a manner for accommodating the invention. Moreover, it should be recognized that the invention could be adapted for use on computers other than general purpose computers, as well as on general purpose computers without conventional operating systems.

With an appreciation of the above description, the ordinarily skilled artisan should recognize that the proposed algorithmic modification to the DHCP protocol accomplishes a separation between a valid IP address space and invalid or “illegal” address which offers distinct advantages over current implementations by virtue of the non-sequential distribution of allocable addresses within a pool. While realizing the aspects of the present invention technically comes at the expense of unused IP addresses, this is of little practical consequence since the availability to administrators of “private” IP ranges and Network Address Translators (NATs) means there is virtually an unlimited number of allocable IP addresses at one's disposal. The result of the present invention's approach, on the other hand, is a robust address allocation and authentication scheme which is difficult to circumvent.

In particular, the security enhancements of the invention enable the quick detection of hosts attempting to impersonate either a DHCP client or a DHCP server in an effort to conduct malicious activities on the network. Such malicious activities could entail attempts to penetrate the network and access resources via SPAM, network scanners, worms, or the like. For example, assuming an unauthorized host which is attempting to impersonate a client does not “guess” a valid IP address within the hop-set on the first try, a simple configuration parameter on the server side—namely, the function ID detector—allows the DHCP server to quickly verify that the client is unauthorized. Similarly, malicious code originating from a host which is impersonating a DHCP server must “guess” the pre-established function which is used by valid DHCP servers on the network to generate the valid address sub-set. Incorrect attempts to do so can also be easily thwarted though the use of the client side match filter.

Attempted theft of network service can also be detected. For example, it is entirely possible that a savvy attacker might try to learn the hop-set and begin communicating on the network. However, the algorithm is yet another road block for malicious hackers to have to overcome in order to gain access to the network's resources, and would require the attacker to be completely passive and learn of the function ID first. This would be difficult in a switch environment in which a robust function is used. It would also be exceedingly difficult to guess the function from the sequence of IPs.

Implementation of the present invention can also result in a more efficient utilization of network resources. For example, since existence of a valid IP can be ascertained quickly using the match filter, unauthorized access can be detected and disabled at the outset without a need for a lengthy message protocol exchange in order to authenticate an IP address.

It is also believed that implementation of the teachings herein will lead to a higher probability of worm containment. By using the described enhancements, a worm would have a best-case probability p of guessing a valid IP on the first try, assuming the full hop-set is used. If less than the full hop-set is actually in use, the probability becomes less. This probability p is calculated by taking the number of IPs in the hop-set divided by the total IPs in the sub-net pool. The probability is also necessarily dependent upon the actual function used generate valid IP addresses, and the quality of the worm's algorithm for “guessing” a valid IP address. The lower bound limit for detection by the worm is (1−p). If p becomes small, there is a high probability of containment of the worm on its very first attempt to scan the network. Even if this probability is low, the algorithm increases the chance for worm containment since the only way for the worm to bypass the containment is to determine the hop-set and only infect the hop-set.

An even more robust adaptation of the present invention could additionally incorporate certain modifications to ARP and RARP. For example, the ARP module could be modified to refuse to send MAC requests with respect to those IPs which have been deemed invalid. To accomplish this modification, each IP address that ARP would need to resolve could initially be passed through the match filter of FIG. 2. If the result is an invalid IP the ARP request message could be deactivated. As for RARP, even though it is a rarely used protocol, if it were left unmodified a malicious hacker could listen to ARP requests and build a list of MAC addresses. From these the attacker could use RARP to find all the IPs on the same segment. If such mechanism exists, a worm could theoretically exploit this to launch an attack on the algorithm. To alleviate this potential vulnerability, RARP could be also modified so that it does not respond to MAC addresses which do not have a corresponding valid IP address.

In its rawest form, implementing the present invention really only impacts the IP generation algorithm on the server side. If transition deployment is required, then the server could readily be updated with the new IP generation algorithm but ignore the function ID in a message. Then the client would not have any compatibility issues. Advantageously also, the invention does not in any way alter the underlying DHCP protocol; rather, it conveniently makes uses of the existing protocol structure through a utilization of its option field for transmitting the function ID.

Another advantage afforded by the present invention is the availability of complementary IPs for fast honeypot. A honeypot is a host that tries to emulate all the unused IPs and emulate services. To do this the honeypot must search for unused IPs to emulate. The aspects of the present invention accommodate a fast algorithm for the honeypot to determine the emulation IPs, rather than having to probe for it. The honeypot would emulate complementary IPs (any IPs that are not part of the hop-set). By doing so, the honeypot can therefore capture all unauthorized access. To accomplish this, the same configuration parameters passed to DHCP client could be passed to the honeypot. In order for the honeypot to make use of this information it must implement all the components of the server and the client side as well. Using the function ID, the honeypot can readily generate the invalid IP space, and it can do so this without having to discover the unused IPs.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A method of allocating an IP address in a local subnet, wherein said local subnet is characterized by a subnet mask IP address and includes a DHCP compatible server and a DHCP compatible client, said method comprising:
a. broadcasting an address discover message from the DHCP compatible client onto the local subnet;
b. generating a valid IP address for offering to the DHCP compatible client, whereby said valid IP address is one of a sub-set of allocable IP addresses which is non-sequentially distributed within an address pool;
c. offering the valid IP address to the DHCP compatible client; and
d. allocating the valid IP address to the DHCP compatible client upon acceptance thereof by the DHCP compatible client.

2. A method according to claim 1 whereby said valid IP address is generated by an address generator residing on the DHCP compatible server, and whereby said address generator produces said valid IP address utilizing a selected algorithm which is operative to generate non-sequentially distributed resultant values based on a linear input variable.

3. A method according to claim 2 whereby said sub-set of allocable IP addresses is defined by mapping each of said resultant values to the subnet mask IP address according to a logical bitwise OR operation.

4. A method according to claim 2 whereby said algorithm is a non-linear function.

5. A method according to claim 2 whereby said algorithm is a linear function of the form f(n)=a*n+b, where a is a constant other than 1, n is said linear input variable and b is a selected offset address constant.

6. A method according to claim 2 comprising selecting said algorithm from a group of selectable algorithms.

7. A method according to claim 2 whereby said algorithm is characterized by a valid function identifier, and whereby said valid IP address is only offered to the DHCP compatible client upon determining that said DHCP compatible client possesses said valid function identifier.

8. A method according to claim 2 whereby said algorithm is characterized by a valid function identifier, said method comprising incorporating a target function identifier within a DHCPREQUEST unicast message and offering said valid IP address to the DHCP compatible client only upon a determination that said target function identifier matches said valid function identifier.

9. A method according to claim 8 comprising generating a dummy DHCPOFFER message to trigger said DHCPREQUEST unicast message.

10. A method according to claim 8 whereby said determination is made by the DHCP compatible server.

11. A method according to claim 9 whereby said target function identifier is transmitted within an options data field of said DHCPREQUEST unicast message.

12. A method according to claim 1 comprising accepting the valid IP address at the DHCP compatible client only upon a confirmation of its validity.

13. A method of allocating an IP address in a local subnet, wherein said local subnet is characterized by a subnet mask IP address and includes a DHCP compatible server and a DHCP compatible client, said method comprising:
a. broadcasting a DHCPDISCOVER message from the DHCP compatible client onto the local subnet;
b. generating a selected IP address for offering to the DHCP compatible client;
c. transmitting the selected IP address as an offered IP address to the DHCP compatible client;
d. ascertaining validity of the offered IP address; and
e. allocating the offered IP address to the DHCP compatible client only upon a confirmation of its validity by the DHCP compatible client.

14. A method according to claim 13 whereby the selected IP address is one of a sub-set of allocable IP addresses which is non-sequentially distributed within an address pool.

15. A method according to claim 14 whereby the selected IP address is generated by an address generator residing on the DHCP compatible server, and whereby said address generator produces the selected IP address utilizing a selected algorithm which is operative to generate non-sequentially distributed resultant values based on a linear input variable.

16. A method according to claim 15 whereby said algorithm is characterized by a valid function identifier, and whereby the selected IP address is only transmitted to the DHCP compatible client upon determining that the DHCP compatible client possesses said valid function identifier.

17. A method according to claim 13 whereby the selected IP address is generated by an address generator residing on the DHCP compatible server, said address generator for producing the selected IP address based on a plurality of inputs.

18. A method according to claim 17 whereby said inputs comprise a linear input variable, a function identifier which corresponds to a selected algorithm which is operative to generate non-sequentially distributed resultant values based on a linear input variable, and the subnet mask IP address.

19. A method according to claim 13 whereby said algorithm is characterized by a valid function identifier, said method comprising incorporating a target function identifier within a DHCPREQUEST message and transmitting the selected IP address to the DHCP compatible client only upon a determination that said DHCP compatible client possesses said valid function identifier.

20. A method according to claim 19 whereby said target function identifier is transmitted within an options data field of said DHCPREQUEST unicast message.

21. A method according to claim 13 comprising passing the offered IP address to a match filter on the DHCP compatible client to ascertain its validity.

22. A method of allocating an IP address in a local subnet, wherein said local subnet is characterized by a subnet mask IP address and includes a DHCP compatible server and a DHCP compatible client, said method comprising:
a. broadcasting an address discover message from the DHCP compatible client onto the local subnet;
b. generating a valid IP address for offering to the DHCP compatible client utilizing a non-linear algorithm, whereby said valid IP address is one of a sub-set of allocable IP addresses which is non-sequentially distributed within an address pool;
c. offering the valid IP address to the DHCP compatible client; and
d. allocating the valid IP address to the DHCP compatible client upon acceptance thereof by the DHCP compatible client.

23. A system for allocating an IP address on a local subnet that is characterized a subnet mask IP address, said system comprising:
a. a client computer system for transmitting IP address request message along the local subnet; and
b. a server computer system for selectively offering a valid IP address to the client computer system in response to said request, wherein said server includes an IP address generator for generating said valid IP address, and wherein said valid IP address is one of a sub-set of allocable IP addresses which is non-sequentially distributed within an address pool.

24. A system according to claim 23 wherein said client computer system is a DHCP compatible client and wherein said server computer system is a DHCP compatible server.

25. A system according to claim 23 wherein said IP address generator produces said valid IP address based on a plurality of inputs comprising a linear input variable, a function identifier which corresponds to a selected algorithm that is operative to generate non-sequentially distributed resultant values based on said linear input variable, and the subnet mask IP address.

26. A system according to claim 25 wherein said client computer system is a DHCP compatible client and wherein said server computer system is a DHCP compatible server.

27. A system according to claim 26 wherein said algorithm is characterized by a valid function identifier, and wherein said DHCP compatible server only offers the valid IP address upon a determination that the IP address request includes the valid function identifier.

28. A system according to claim 26 wherein said algorithm is characterized by a valid function identifier, said DHCP compatible client operative to broadcast a target function identifier within an options data field of a DHCPREQUEST unicast message, and said DHCP compatible server operative to offer said valid IP address only upon a determination that said target function identifier matches said valid function identifier.

29. A system according to claim 23 wherein said client computer system includes a match filter for receiving the valid IP address and confirming its validity.
